(19) United States
(12) Patent Application Publication
(10) Pub. No.: US 2012/0295662 A1
(43) Pub. Date: Nov. 22, 2012

(54) Universal Remote

(76) Inventor: Jeremy Haubrich, Jeannette, PA (US)

(21) Appl. No.: 13/295,858

(22) Filed: Nov. 14, 2011

Related U.S. Application Data
(60) Provisional application No. 61/458,133, filed on Nov. 18, 2010.

(51) Int. Cl. G05B 11/01; H04B 10/00; H04M 1/00

(52) U.S. Cl. 455/556.1; 340/12.25; 398/106

(57) ABSTRACT

A universal remote control system and method for employing a centralized database for programming the universal remote control (URC) to control the operation of appliance(s). The appliance(s) may or may not be made by different manufactures. The centralized database is accessible via the Internet and includes many different appliances made by many different manufacturers. The user may access a web site of the centralized database and manually enter electronic appliances identifying data that the URC is desired to operate, then the centralized database sends the appropriate command code data to the URC either directly or temporarily downloads them into a computer to be later loaded into the URC. The centralized database includes command codes for appliances such as TV sets, DVDs, CD systems, alarm clocks, and VCRs, music synthesizers, toys, stereo systems, ovens, washing machines, timers, power strips, and the like.

### CROSS REFERENCES TO RELATED APPLICATION

This application claims the benefit of the filing date of U.S. provisional application No. 61/458,133 filed Nov. 18, 2011, for “Universal Remote Control”, and herein incorporated by reference.

### FIELD OF THE INVENTION

The present invention relates generally to remote controls for controlling consumer appliances, and more particularly to remote controls for controlling a variety of consumer appliances from various manufacturers, and which are capable of using data downloaded from the internet or other data sources to control the appliances. One embodiment of the present invention is an intelligent touch screen type universal remote control that is user-friendly to operate.

### BACKGROUND OF THE INVENTION

Remote controls have been in existence since the 1950s. The first remotes were connected to televisions by a cable. Around 1955 Zenith™ introduced the first wireless remote control. The remote flashed bright visible light at light sensitive receivers on the television. Unfortunately if strong sunlight or other strong light sources of light struck the television, the television would sometimes change channels all by itself.

Today remote controls are used on all sorts of electronic appliances in industry and domestically. The remotes generally found today in households/industry typically use infrared beams as the chosen form of electromagnetic energy to operate all types of electric appliances.

The command data transmitted and received from an appliance are formed of a series of infrared light pulses (marks) of constant duration in time with spaces between them that are either one duration or another. A mark followed by the longer space is designated as a binary “0” and a mark followed by the shorter space is designated as a binary “1”. There are enough pulses in a data symbol (i.e. command code signal) to represent perhaps four-eight bits of data, and may be varied in accordance with a manufacturer preference. A unique binary signal is transmitted and represents one of the plurality of functions on an appliance that may be commanded by pushing each of the remote control keys/buttons. For example on an appliance the command code signal (i.e. combination of bits) for volume-up is uniquely distinguishable from the combination of bits (i.e. code signal) for mute.

Manufacturers establish proprietary IR codes for a particular appliance, and will typically provide a proprietary remote control with the necessary IR commands already loaded into its memory for controlling the appliance. Typically the command code signals from one manufacturer may and usually do differ from command code signals of other manufacturers for appliances.

In today's advanced hi-tech environment, most households are loaded with all kinds of electric household appliances, such as household entertainment audio, television, DVD, hi-fi stereo system, air conditioner, microwave oven, refrigerator and other types. These appliances are usually furnished with remote control function for a user's convenience.

Additional problems occur as a consumer acquires various remotely controlled appliances, where each is typically supplied with a separate remote control transmitter. The more appliances the greater the problem of an appliance remote being misplaced or being confused with other remote controllers. The homeowner can become confused as to how each remote control device operates or how the control device is to be programmed.

In response to this problem, universal remote control transmitters for controlling more than one appliance have been developed in the marketplace These universal remotes either contain pre-programmed data of a number of different command code signal and encoding patterns used by various manufacturers, so that the appropriate one or more command code signals can be selected by the user, or are programmable from the remote controls that accompany the equipment to be controlled.

Pre-programmed universal remotes come equipped with control command code signals for a large number of different manufacturers appliances, typically all the command code signals for the more popular appliances in the entertainment appliance market. Many pre-programmed command code signals are required to be pre-stored by the manufacturer in the universal remote controls memory. More and more command code signals for appliances are necessary in order to operate the myriad of remotely controlled electronic appliances in the marketplace. Also command code signals have become more complicated (e.g. encrypted), and employ electromagnetic signals throughout the electromagnetic wave spectrum. However currently most basic remotes operate with an infra red link to transmit control signals to the appliance. In addition to infra red signals, basic remote controls for appliances have been manufactured that use ultraviolet as well as radio frequencies (RF), especially short range radio frequency protocols (e.g. BLUETOOTH). Such remote control signals in the art are now encrypted and more complex. In addition to hardware and software for encrypting the remote control signals the software includes authentication and error detection and correction capabilities. More universal remote control hardware and software, including but not limited to memory expansion, has become necessary and it is anticipated more software and hardware requirements will continue to increase as the command code signals, software, data and associated features becomes ever more complex in the industry.

These pre-programmed universal remote controls require that the users manually enter identifier code numbers, this can be time consuming and difficult for many users. A “identifier number book” typically comes with the universal remote control. Should the purchaser loose the “identifier number book” they cannot reprogram the universal remote control. Further, a consumer is commonly given about a half dozen different potential identifier numbers for a manufacturers appliance. A user for instance must then try entering the half dozen identification numbers, one at a time, until the user finds and enters the correct identification number. For some appliances made by the same manufacturer different models may use identical command code signals for some functions but not all the functions. Therefore a user after entering an incorrect identifier number for the target appliance model may be able to control some functions of the appliance but not all the appliances functions causing further frustration and confusion.

In addition to the pre-programmed universal remote control transmitters discussed immediately above, learning universal remote controls have been developed which receive the control command signals, typically infrared codes, from another remote control such as an appliance manufacturers originally provided remote control. The “learning” universal remote controls in the art generally store the frequencies and pulses for an appliance signal into memory, these signals have assigned corresponding image physical keypad buttons on the learning universal remote control. After the learning programming is complete, depressing the keypad buttons/keys prompts the learning remote control transmitter to re-transmit the command code signals stored within its memory. This allows the user to consolidate the control of several remotely controllable appliances each having an individual original remote control into a single hand-held universal remote control.

The learning of control command code signals is very time consuming and it is difficult to ensure proper learning of the code. An individual must expend significant amounts of time learning infrared signals from another remote control. Typically a user must save these command code signals within the universal remote control and assign the command code signal to a physical button on the remotes keypad. This can be very inconvenient and frustrating for the user (e.g. purchaser) of the universal remote.

As discussed above in some universal remote controls, the IR command code signals and data for various appliances are typically pre-loaded into the remote control's memory. Even so, the consumer might have to use a trial-and-error basis to determine which command code signal control to use for a particular appliance. It may also be the case that for a pre-programmed universal remote control that the proper command code signal for the appliance to be controlled was not pre-progammed by the manufacturer of the remote control. This might occur because the appliance was a new model, very old model, or simply not popular enough as determined by the manufacturer of the remote control. The user (e.g. purchaser of remote) would typically then be required to have these appliance model command code signal programs loaded by a professional at a service location, or may even be required to send the universal remote control back to the manufacturer of the universal remote control to be loaded with the command code signals.

Neither the identifier number code nor learning method of programming a universal remote control is efficient and it causes many persons to forego purchasing a universal remote control or abandon an already purchased universal remote control.

Presently touch screen based universal remote control devices offer more flexibility than universal remotes with only physical buttons. Some universal touch screen remote controls are configured to control appliance functions by connecting the universal touch screen remote control device to the internet and by downloading a set of configuration data. See U.S. Pat. No. 7,586,398 (Huang et al.).

Also, as technology continues to advance forward, combined PC and TV systems have recently been introduced which allow television screens to be employed as a personal computer display (monitor) screen using wireless keyboards and a wireless mouse. For instance a combined television and personal computer is disclosed in U.S. Pat. No. 5,675,390. Also, game consoles and other internet access devices have been introduced which add internet access capabilities to conventional televisions. Game consoles often employ a wireless remote control to interact with and play games,

Households incorporate cordless phones in their telephone systems to enjoy the advantage of mobile phone capability without the restriction of telephone cord.

Such newer technologies and problems have created the need of universal remote controller to have one centralized device for remote control function of all types, makes and models of electrical household appliances.

### SUMMARY

A primary object of the present invention is to provide a universal remote control that will overcome the shortcomings of prior art universal remote control devices.

As described herein, the universal remote control of the present invention may connect to the internet or other data source directly or by a household personal computer. A wired connection may be made through a USB connection or other serial connection to a personal computer, through a standard connection for telephone lines or other digital cable formats for transferring data from other hardware devices.

The invention combines benefits of a portable wireless phone, mouse and keyboard with the convenience of universal remote control unit to solve the frequent problem of missing remote(s), mouse (s), portable telephone(s) or keyboard(s).

The invention avoids the confusion in a household that arises when a person desires to operate an appliance and is uncertain which of many remote controls is needed. A homeowner must select from a collection of remote(s), mouse(s), portable telephone(s) or keyboard(s).

By combing a plurality of remote(s), mouse(s), portable telephone(s) or keyboard(s) into one universal remote control the invention limits the need for a plurality of independent power sources otherwise necessary to power a plurality of remote controls.

The universal remote control invention permits an alarm clock, including snooze alarm circuit to be activated remotely by an infrared signal or local radio signal such as a BLUETOOTH signal.

The present invention relates generally to universal remote control units, and, more particularly, to universal remote control units for remotely controlling a plurality of entertainment appliances and also acting as a flashlight, alarm clock, snooze timer, mouse and telephone.

The universal remote control invention has a memory that can store the command code signal programming for many different controllable appliances.

The universal remote control invention has a touch screen display were control image keys can be displayed for each controllable appliance for which remote control is desired.

The universal remote control invention can also learn command code signals from a remote control apparatus but only when connected to the universal remote control manufacturers designated web-page on the internet via a USB connection or other serial connection means. Said designated web-page transmits encrypted instructions via the USB port to the remote unlocking and enabling the remote to operate in a learning mode.

Further the present universal remote control invention has the ability to both transmit and receive multiple infra red beams and radio signals.

Accordingly, it would be desirable to provide a remote control device that is truly universal in that the remote control device would be operable to control every controllable device whether operable by radio signal, infra red beam, visible light or other electromagnetic frequency.

According to the invention a universal remote control system having input means for inputting commands, signal output means for supplying infrared signals to a controlled appliance, a central processing unit connected to the input means and to the signal output means, memory connected to the central processing unit and data wire connection means for enabling new command code signal related software/data to be supplied from outside the system to the universal remote control invention.

The universal remote control invention provides for communication between at least both BLUETOOTH enabled appliances and infra-red controlled appliances.

The universal remote control invention relates to a remote control for controlling various consumer appliances made by various manufacturers. The universal remote control has both physical and/or on-screen function actuators.

The universal remote control invention system includes a universal remote control user's account on the World Wide Web, the account is accessible via a web browser the account may have user appliance command code signal software, appliance identifier numbers and other appliance data important for programming and operating user appliances with the user's universal remote control. The internet transmissions are secured by encryption and the user's website account is password protected.

The universal remote control invention may also employ memory cards for loading command code signals and related software/data.

The universal remote control invention includes a display screen and input means, and use of the universal remote is password protected. A predetermined region of a home page display may be set aside for entering the password.

The universal remote control invention may be used to control a variety of consumer appliances from a variety of manufacturers.

A universal remote control is provided with a method for activating an alarm which may include a snooze alarm feature. The alarm clock and/or other audio appliances are activated from a convenient position at a distance from the alarm clock and/or audio appliances.

The universal remote control of the present invention may include a touch screen, an infrared transmitter for transmitting remote control code signals; an infrared receiver for receiving remote control codes to perform a learning procedure; a basic physical button set arranged on the body; and a microprocessor and a memory unit. The memory unit stores remote control command code signal files. The touch-type screen can be activated by pressing a physical button from the basic button set to display the home page screen having a main menu page having an image key for each appliance controlled by the universal remote. Each appliance once selected further having at least a corresponding home page screen having a plurality of function image keys, the function image keys corresponding to various functions to be controlled for that selected appliance.

Other objects and advantages of the present invention will become apparent from the detailed description of preferred embodiments which follow, when read in conjunction with the drawings.

### BRIEF DESCRIPTION OF THE DRAWINGS

For use in better understanding the exemplary systems and methods for setting up a universal remote control which are described hereinafter, reference may be had to preferred embodiments shown in the following drawings in which:

FIG. 1 illustrates an exemplary system of the invention wherein a universal remote control provides commands to control functions of a TV set, DVD, CD, alarm clock and VCR;

FIG. 2 illustrates a top view of a hand held universal remote control according to the present invention;

FIG. 3 illustrates a block diagram of a platform for the universal remote control according to the present invention;

FIG. 4a illustrates a first front page control screen embodiment of a DVD appliance for the universal remote control according to an embodiment of the present invention;

FIG. 4b illustrates a front page control screen of a TV appliance for the universal remote control according to an embodiment of the present invention;

FIG. 4c illustrates a front page control screen of an Alarm Clock appliance for the universal remote control according to an embodiment of the present invention;

FIG. 4d illustrates a second front page control screen embodiment of a DVD appliance for the universal remote control according to an embodiment of the present invention;

FIG. 5 illustrates a remote controlled power strip.

### DETAILED DESCRIPTION

The term “original remote control” is referring to the remote control device that is or was used to remote control the electronic appliance prior to incorporating its functions in the universal remote control device 10 described in the current invention. This can be the original remote control device delivered with the electronic apparatus, a substituting remote control device or another previous universal remote control device that the user wants to replace.

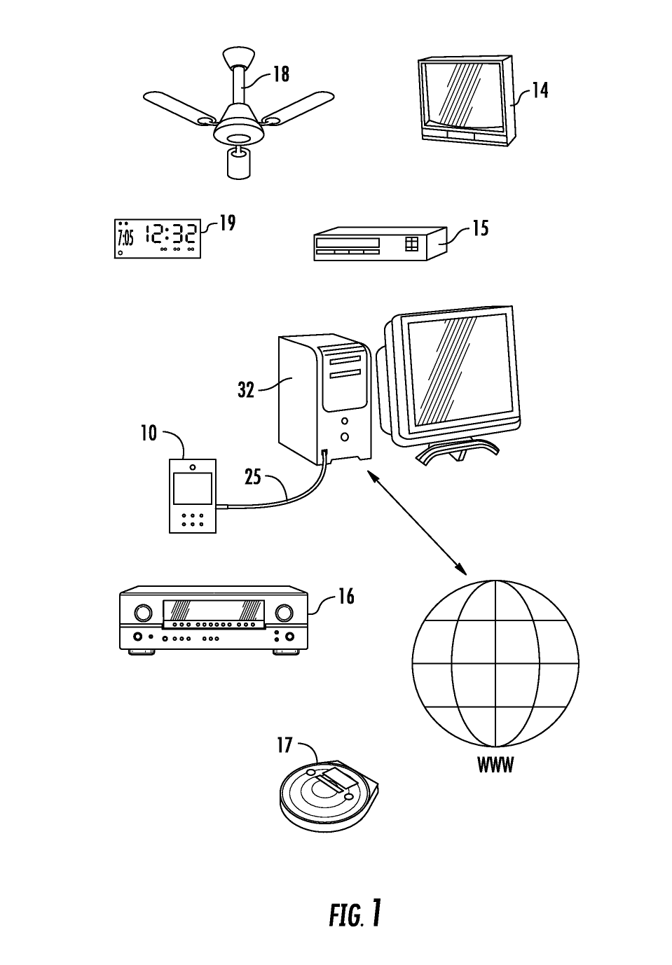

The following describes various systems and methods for setting up and configuring a universal remote control to command one or more functions of one or more types of appliances of one or more manufacturers. By way of example, FIG. 1 illustrates an exemplary system wherein a universal remote control 10 is provided whereby the universal remote control 10 may be setup to command functions of the appliances, illustrated as a TV set 14, a VCR 15, a DVD player 16, CD player 17, a fan 18 and alarm clock 19.

Command control code signals for appliances may be pre-stored in the universal remotes memory, learned into the memory for instance by using an original remote control that was supplied with a household appliance, or downloaded from a remote source, e.g., from a source via the Internet, and loaded into memory 24.

The universal remote control 10 in order to control each and every one of the different appliances 14-19, must have the each and every correct infra-red code. A centralized device database may include command code signals for appliances of different types and manufacturers as well as touch screen graphical icons for each appliance to be displayed on the universal remote control 10 to function as an interface to remotely control various appliances.

As illustrated in FIG. 1, the universal remote control 10 can be connected by a USB cable 25 for accessing the centralized device database server. The centralized device database server is first provided with the appliances identity information, upon receipt of the appliances identification and a request the centralized device database server downloads to the universal remote control 10 information from the centralized device database needed by the universal remote control 10 to configure itself to communicate with and/or control the appliance corresponding to the device identity information

For use in downloading data to setup the universal remote control 10, the appliance identification information; such as brand-name manufacture, model and serial number for the remote, may be stored in the memory of the universal remote control 10, either software or firmware memory. To upload the identity information to the database server, as illustrated in FIG. 1, the universal remote control 10 is connected to a computer 32 to thereby allow the identification information to be read from the universal remote 10 memory and be communicated to the centralized database server on the internet (or other network). As an alternative the server may also include interactive web pages for a client to manually type-in the remote control's brand-name manufacture, model and serial number. A client may type-in the identification information for many different appliances in order to download the appliance operating IR codes to the universal remote connected to the computer 32 via the USB line 25.

Upon receipt of the appliance(s) identity information from the universal remote control 10, the centralized device database server uses the identity information to select from a command code signal library stored in the central database server one or more command code signals recognizable and appropriate for the identified appliance. This data is then returned from the centralized database server to the computer 32 whence it may be transferred directly back to the universal remote control 10 if the universal remote control is still in communication with the computer 32. Alternatively, the data may be stored on the computer 32 for later transfer to the memory of the universal remote control 10 during a subsequent hookup with the universal remote control 10. Once the data is transferred to the universal remote control 10 the data is used in a manner well known to those of skill in the art to setup the universal remote control 10 to control the operation of the appliance(s).

The universal remote control 10 is preferably upgradeable whereby additional control codes, iconic representations, or other appropriate command code data, can be downloaded to the universal remote control device 10 by connecting the universal remote control device 10 directly to an external device or indirectly to a server via the Internet, via a cable set top box, etc. See U.S. Pat. No. 5,537,463 and U.S. Pat. No. 5,689,353 which are hereby incorporated by reference in their entirety.

Probably the most effective manner in which the programming, command code signals and other relevant data can be loaded into the remote control apparatus 10 would be via a website established by the universal remote 10 manufacturer of the machine or appliance to be controlled. The website would be accessible via the Internet and could be updated by the manufacturer as need arises. The website may provide each client with an account; each account file has online storage for storing and maintaining a clients (e.g. owner of universal remote control 10) universal remote control data. Each client may be assigned a unique account number and password so that only that client may access their confidential account information and universal remote control programming data, including but not limited to command code signals.

Alternatively the programming, command code signals and other relevant data could be loaded on a floppy disc, CD, DVD or memory card to be inserted and loaded onto a computer to be later downloaded via data cable 25 onto the universal remote 10.

Similarly, it is contemplated that the download of the programming, command code signals and data from the manufacturer's website can be loaded into the universal remote control apparatus 10 via the data cable 25.

Preferably, the remote control apparatus 10 will have a broad spectrum application and will in addition be operable as present conventional “learning” universal remote control devices. Many existing universal remotes may receive data or command code signals from an original remote control device through the infrared receiver 27 so that the universal remote control apparatus 10 can “learn” the requisite commands from an previous universal remote control or original appliance manufacturer remote control.

Once loaded, the universal remotes 10 preprogramming will be able to provide a control panel touch screen on the display screen in the form of touch screen image keys/icons to provide the manufacturer's control functions for the appliance to be controlled. It is contemplated that the universal remote 10 will assign one of its own preprogrammed touch screen icons/keys to controlled functions on those previous universal remote controls or original appliance manufacturer remote controls that have manual buttons.

The universal remote will transmit the electromagnetic command signals that the universal remote control apparatus 10 must employ to communicate with the many possible appliances to be controlled. Accordingly, the universal remote 10 is equipped with well known transmitters and receivers at 27 for both receiving and transmitting electromagnetic signals used by appliance remote controls currently in commerce. The programming command code signal might be a radio signal, and the command code signal data includes information regarding the frequency at which the radio signal is to be broadcast. Or if the control command signal is sent via an infra red beam through a transmitter, the programming will provide the microprocessor memory with the instructions for transmitting the correct pulses (binary code) of IR light for controlling the appliance.

Such a universal remote control apparatus 10 would be truly a universal remote control capable of controlling every remotely controlled appliance for which the programming, command code signals and other relevant data can be loaded into the universal remotes 10 memory and executed by the microprocessor, or which can “learn” from a previous universal remote or original appliance manufacturer remote control.

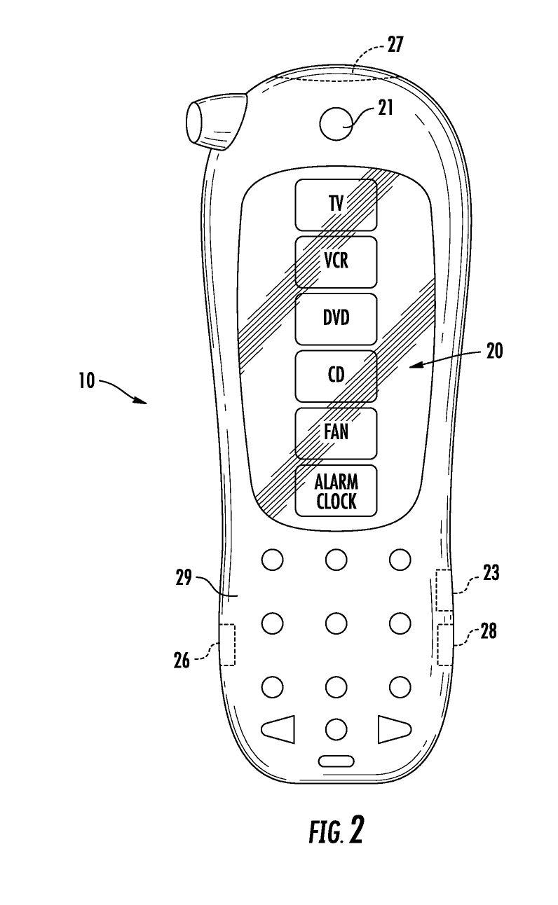

In “learn” mode, the remote control code may also be received from the TV, VCR, DVD player or other appliance and is stored in the remote control memory as is well known in the art. The universal remote control 10 may be adapted and preprogrammed so that a newly installed consumer electronic appliance activates the setup of the universal remote control 10 by transmitting to the remote control a signal identifying the type of appliance just installed and the infrared (“IR”) remote control code an/or bandwidth to operate the appliance. Alternatively the universal remote 10 might include a setup image key (not shown) on the touch screen home page shown in FIG. 2 or a physical setup button (not shown) to initiate data transmission from the newly installed appliance. See U.S. Pat. No. 6,437,836 (Huang et al.) which is hereby incorporated by reference in its entirety.

As described the universal remote control 10 may connect to a centralized database on the internet directly or by hooking up to a household PC. The connection may be through wired communications or by wireless communication. Wired connections may be made through a USB connection or other serial connection to a PC or other hardware device. Alternatively the connection may be made through any well known telephone line modem connection. Said wireless internet connections may be through the use of BLUETOOTH, Wi-Fi or other wireless links.

In the case of a direct link, the remote control 10 will either have a standard telephone connection point (not shown) with an internal modem, such that a telephone connection could be made between the remote control 10 and the internet. The remote will be programmed to, by automatic default, visit the website of the manufacture of the universal remote control and display the website on the touch screen display. The source connected to may be a standard ISP company, in which case the remote control would contain all of the necessary internet protocols and web client technology to be able to send “http” requests and receive data or download program “applets” in response. The source connected to may instead be dedicated solely to serving remote controls 10 of the present invention. In that case, the consumer would not have to have access to a pre-existing ISP account, as the necessary data for initial setup and configuration of the remote control 10 for any appliance identification data loaded in the memory of the universal remote by the user could be performed simply by a phone connection.

With connection via a household computer, companion household computer software could use a pre-existing service with an ISP to download all relevant data, for subsequent transfer to the remote control 10. If the consumer does not have an ISP account, but the PC is equipped with a modem, the same companion remote server may be used as for the case described where there is a direct telephone connection from the remote control 10. When used in conjunction with a PC, the remote control 10 would not require the additional communications hardware and/or software (e.g. modem . . . ) The cost savings from avoiding the need for such additional hardware would result in a less expensive universal remote. If a potential purchaser did not have a computer, the embodiment of a universal remote control 10 with integral internet connection hardware and software would be less expensive than purchasing a computer.

New programming, command code signals and/or software and other relevant data may be made available through the internet and downloaded into the universal remote 10 which can use this data for the targeted electronics appliance. A preferred embodiment provides the universal remote user with the ability to select some features such as display image keys/icons, formats or layouts available at the centralized database on the World Wide Web. According to the selected appliance and/or features all remote control programming, command code signals and other command code information for a selected appliance, or programming for a selected feature may be downloaded into the microprocessor memory of the remote control. In a preferred embodiment the user can then display and operate the downloaded remote control commands (or selected features) on a graphical touch screen.

To assist in downloading data to setup the universal remote control 10 to operate appliances, the appliance and/or function identity information supplied to the universal remote 10 for the purpose of setting up the universal remote control 10 may be stored in memory of the universal remote control 10. The identity information can be read from the memory and communicated to the appliance centralized database server during an on-line communications session. Alternatively, the appliance/function identity information may be uploaded from the universal remote control 10 into an intermediate computer 32, such as a personal computer, set top box, etc. for future off-line communication to the centralized appliance database server. Similarly, the data returned from the centralized appliance database for use in the universal remote control 10 can be loaded into the memory of the universal remote control 10 during an on-line communications session or this information can be downloaded to the intermediate apparatus 32 for subsequent, off-line downloading into the memory of the universal remote control 10.

To upload the identity information to the centralized appliance database server, as illustrated in FIG. 1, the universal remote control 10 may be placed in communication with a computer 32 which, in turn, is capable of communicating with and accessing the centralized appliance database server. Access to the centralized database server may be via direct connection or via the World Wide Web as shown, or some other network.

Upon receipt of the identity information from the universal remote control 10, the centralized database server uses the identity information to select from a command code signal library stored at the centralized database. A command code signal file corresponding to the appliance identification information is retrieved. This command code signal file is forwarded from the centralized database server to the computer 32 whence it may be transferred directly back to the universal remote control 10 if the universal remote control is still in communication with the computer 32. Alternatively, the data may be stored on the computer 32 for later transfer to the memory of the universal remote control 10 during a later communication with the universal remote control 10.

Appliance identity information may be used to retrieve from the centralized database graphical user interface elements, such as command key representations and layouts that are appropriate for the identified appliance and/or function. The graphical user interface elements may then be downloaded as described above to the universal remote control 10 for use in providing a touch screen display by which the user can command the operation of the appliance.

The computer or a universal remote having an internal modem as discussed above may be in communication with the internet via various well-known means. The universal remote control manufacturer's library of command files for appliances in commerce is preferably accessed by users via a web page which allows the users to identify themselves (e.g. PIN & password) and modify user settings, add or delete appliance files and otherwise customize their universal remote control 10 as desired. The user may input various conditions and specific requirements regarding the operation of the external electronic appliances 14-19. The user settings and files may be modified at anytime via the web page or other means. In a preferred embodiment the library of command code signal files at the central database is continually updated.

The command code signal files may comprise of basic product information, type, brand, model, year, communication type, and signal configuration data. It can be appreciated that additional types of electronic appliance information (e.g. appliance warranty expiration) may be received and stored on a central database website. The website is created and constructed at an ISP chosen by the universal remote control manufacturer. The central database website is preferably updated at periodic intervals regarding for instance command code signal files for new electronic appliances introduced in the market.

It is contemplated that a user while on the website may enter a type, brand and model of an electronic appliance, the website then generates a command code signal file that is then downloaded to the computer or a universal remote having an internal modem. To this end, FIG. 2 shows a exemplary universal remote control 10 suitable for use in this manner which includes an internal microcontroller, an infra red transmitter and a receiver (or transceiver), generally labeled as 27, various physical command buttons 29, and a physical power button 21 and a touch screen 20, as all are well known in the art. As illustrated, it is to be understood that images of keys displayed on a touch screen 20 could be substituted for or used in conjunction with the physical buttons 29. It is also envisioned that another embodiment of the universal remote 10 may only have one physical button such as for power.

Remote controls for many household appliances have sound controlling keys, such as the mute and volume keys. Remote control keys in the prior art cause an infra-red signal to be transmitted to a photo-detector on the television or other piece of audio-video equipment such as a stereo. A different signal is transmitted by the remote for each key pressed by a user. Universal remote controls have, as a result, been made available for controlling two or more pieces of audio-video equipment from different manufacturers. Sound emitting devices in the household include music synthesizers, toys, TVs, stereo systems, ovens, washing machines, timers, alarm clocks and the like. Accordingly it is contemplated that the physical command buttons 29 include at least up/down volume arrows as shown in FIG. 2 as well as a mute button. The volume arrow and mute command buttons are programmable to individually operate different appliances in different modes (e.g. TV, Stereo . . . ). It is contemplated in one preferred embodiment that these physical volume arrows and mute buttons will control the audio (if available) for the appliance controls being displayed on the universal remotes 10 touch screen 20 at that time.

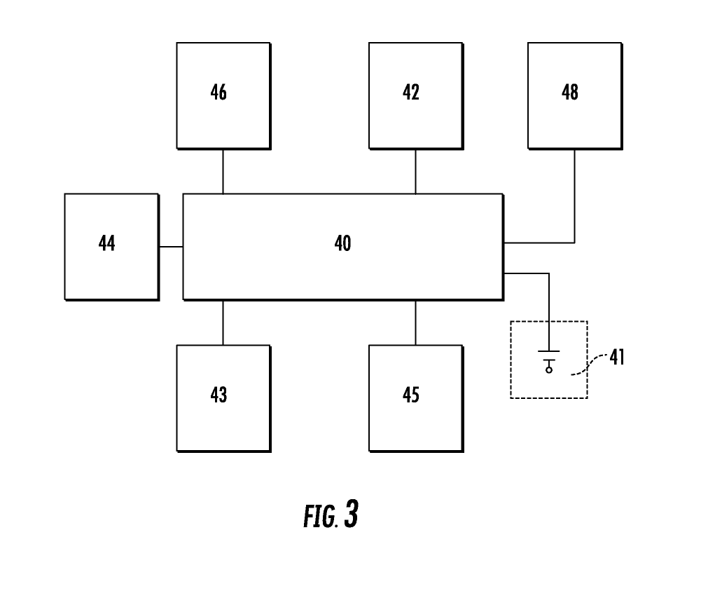

FIG. 3 illustrates a block diagram for the hardware architecture for the remote control employed in the instant invention. The instant invention employs a central microprocessor 40 communicating via a bus to memory 42, physical command buttons circuitry 46 for command buttons 29, a piezoelectric clock and timer circuitry 44, transmission/reception circuitry 48 for IR transceiver 27, a power supply 41, touch screen display circuitry 43 for the touch screen 20, and input/output circuitry 45 for allowing the universal remote control device 10 to exchange digital communications with an external source (e.g. USB, memory card, serial data line, parallel data line . . . ).

The hardware architecture illustrated in the block diagram of FIG. 3 comprises a general purpose, processor system which is controllable by software. The software may include routines, programs, objects, components, and/or data structures that perform particular tasks that can be viewed as an operating system together with one or more applications. Any well known operating system may include JAVA, WINDOWS CE, SYSTEM 7.X other operating systems that support a graphical user interface (GUI).

As will be appreciated, the memory 42 includes executable instructions that are intended to be executed by the microprocessor 40 to control the operation of the universal remote control device 10. In this manner, the microprocessor 40 is programmed to control the various electronic components within the universal remote control device 10.

EEPROM may be employed as memory 42 to store user entered data including but not limited to appliance identification, codes, security software and other software applications and data either downloaded or entered manually directly by a user. As an alternative to EEPROM, FLASH or other types of well-known non-volatile memory may be employed. In addition other type computer-readable media, such as RAM, ROM, SRAM, FLASH or the like can be either substituted for EEPROM or may supplement the EEPROM.

The memory 42 may likewise be configured to at least have a portion of non-volatile memory such that data is not required to be reloaded for instance when new batteries are used to replace existing batteries for the power supply in the remote.

For remotely controlling the operation of different types of appliances, brands and models, the memory 42 includes a set of command code signal files. Each command code signal file includes data and software for an appliance to enable the remote control to transmit and receive IR codes to and from an appliance for the purpose of controlling the operation of the appliance. The software and data from each appliance file is processed by the operating system. The microprocessor operating system executes the instructions for an appliance and transmission circuit 48 sends a signal via IR transmitter 27. The IR command code signals are transmitted in a format recognized by an identified appliance.

The set of command code signal files may include permanent memory command files for popular appliances in the marketplace and/or command code signal files that are downloaded into the memory from an external source such as a PC connected to the internet. The ability to download command code signal files allows for the universal remote to operate a much larger group of appliances and permits the remote to function to control future makes and models of appliances that have command code signals not yet been determined. For additional information regarding updating the memory in the instant invention with command code signal files, U.S. Pat. No. 4,959,810 is incorporated herein by reference in its entirety.

To cause the universal remote control 10 to perform an action, the universal remote control device 10 is adapted to be responsive to events, such as an operator input with a physical button 29, with the touch screen display 43, or a signal from a connected external source such as a personal computer. In response to an input, appropriate software instructions within the microcontroller are executed. Whenever a physical button 29 or image key on the touch screen display 20 is pressed, the microcontroller reads a command code signal file corresponding to this image key or command button from the memory and transmits the command code signal to an appliance in a format recognizable by the appliance.

The infrared command code signals for the appliances include a wide range of different command code signals for operating different electrical appliances manufactured by the same or different manufacturers. The command code signals may employ several modulation schemes for infrared command code signals. For instance different types of gated carrier frequencies may be employed. Carrier frequencies for some infrared remote control transmitters are in the frequency range of 20 Khz to 45 Khz. The method of modulation may include both fixed and variable bit periods, variable burst widths or burst modulation schemes. The modulation scheme for an appliance may be any random pattern of ones and zeros independently chosen and determined by an appliance manufacturer.

After the device 10 has been in use for some time and the memory 42 needs to be updated with command code signals and data for new appliances and/or appliance functions, the remote control 10 can be simply and easily updated via an ordinary personal computer with a USB port that may be coupled to the remote control USB interface port 23. Alternatively other serial and parallel interface ports well known in the computer industry may be employed. In addition the memory can also be updated via memory card slot 28 in communication with the memory 42. The card slot 28 may be a slot designed to receive a SD card or other memory cards employed in the computer industry.

The display 20 used in the universal remote control 10 according to the present invention is a touch screen, often, but not limited to, an LCD-based touch screen. Another example of a display type that can be used is an OLED (organic light-emitting diode) display. The display 20 may be a monochrome screen having grey levels or a color screen. The display 20 is, amongst other things, used for displaying the original remote control device of an appliance. Therefore, the size and shape of the display is preferably that of most original common remote controls in the market can be easily displayed, e.g. it may have an elongated rectangular shape.

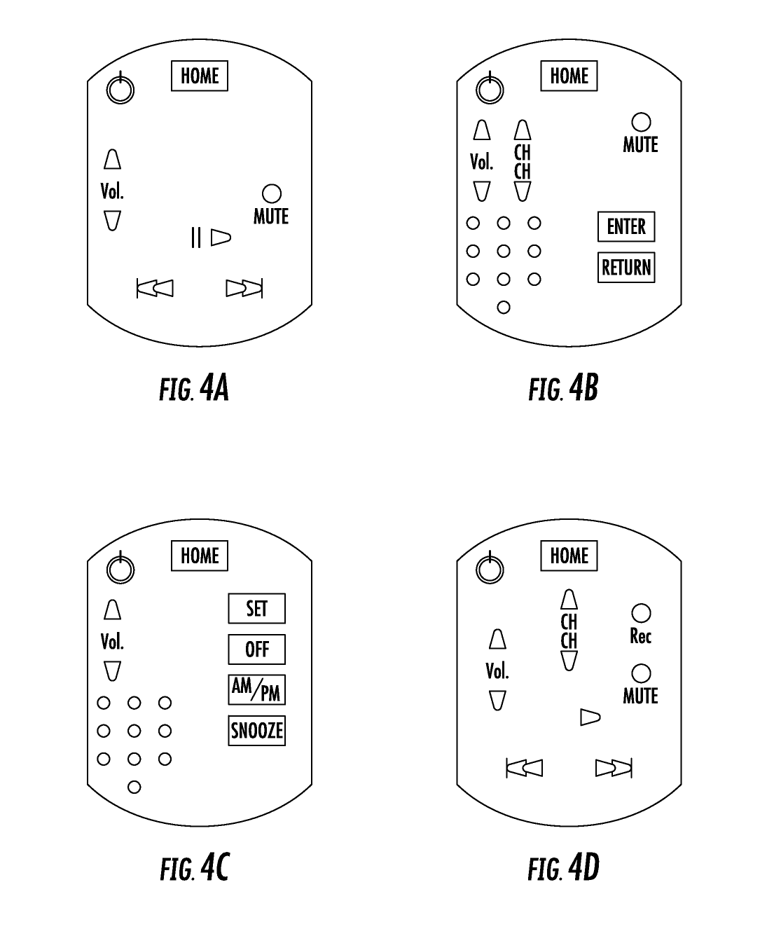

By employing a touch screen, one can dynamically generate remote control buttons, thereby avoiding the constraints associated with determining which particular buttons should be included in the design of a universal remote control, and which buttons should be left out. The generated remote control emulates the original remote control included by a manufacture with the appliance. The emulated remote control displayed at 20 on the universal control shown in FIGS. 4a-4d include an image key directly corresponding to each button and/or function on the manufacturer's original remote control. In one exemplary embodiment of the universal remote invention the remote would be continually programmed to as closely as possible simulate a replica of the physical buttons on the appliance manufacture's original remote control. In another example the initial screen for each appliance might present a user with only the most commonly used buttons and/or image keys for an appliance (e.g. volume up, volume down, numerical buttons). Alternatively it is contemplated that a user may customize a display screen for an appliance as desired.

As illustrated in FIG. 2 command image keys of various appliances are shown. These command image keys on the touch screen display 20 are for placing the universal remote control 10 into an operational mode to transmit commands to one or more target appliances that have been associated with that operational mode key. For example as shown in FIG. 2, a “TV” mode key may be activated to place the universal remote control 10 into an operational mode to transmit primarily television function commands; a “VCR” mode key may be activated to place the universal remote control 10 into a mode to transmit primarily VCR function commands, etc. In addition to these image keys shown in FIG. 2, the universal remote control 10 may have a “home theater” selection which may be activated to place the universal remote control 10 into an operational mode for commanding multiple target appliances within a “home theater”. The details of controlling a “home theatre” will be described later herein.

In the “home theatre” mode the universal remote 10 from a single front page commands functions of various appliances. A command image key on the front page in this mode transmits operating commands to one or more “home theater” target appliances upon pressing an image key.

For example in an embodiment of this invention the “home theatre” mode, volume control commands maybe transmitted to a stereo amplifier, channel selection commands may be transmitted to the television, a record command might be transmitted to a DVD player and television schedule request might be transmitted to a personal computer. The intended target appliances for a command key or groups of command keys within the “home theater” operational mode may be predefined in the universal remote memory or as is typical in the art, may be user programmable.

The appliances may be displayed to the user of the universal remote control device in alternative formats than illustrated in FIG. 2. It will be appreciated that screen 20 may incorporate other layout display arrangements (e.g. displayed lists, tabs . . . ).

In a preferred embodiment, the mode display icons may include small pictures of household appliances.

Similarly, the graphical format and icons for all subsequent drop-down pages may be designed as desired by the universal remote control manufacturer. It will also be appreciated that the number of appliances the universal remote control 10 can be setup to control are a matter of universal remote control manufacturer's choice. As will be appreciated, all of the iconic representations described herein can be predetermined at the time of manufacture of the universal remote, can be user alterable, and/or can be downloadable.

Furthermore, multiple panels can be displayed on the home page screen, each panel including controls for just one appliance. In combination with any of the invention embodiments disclosed herein or another embodiment, it is a preferred embodiment of the invention that the user be provided with a image key means or physical button means, such as arrows, whereby a user may select to navigate between screen pages.

While not intended to be limiting, the universal remote control device 10 will be able to control household appliances such as TVs, VCRs, CD players, DVD players, personal computers, digital video recorders, lighting, window fixtures, thermostats, household alarm systems, etc. An icon for each appliance may be stored in the universal remote control memory. It will be understood that these images/icons could be provided at the time of manufacture of the universal remote control device 10 or could be downloadable into the memory from an external source.

In addition it is contemplated that a user may have a choice of multiple icons to select from to represent an appliance. Since multiple icon images may be available for use when displaying the appliance representation, the user may customize the graphical user interface by selecting which image the user would like to include on the home page touch screen when universal remote control device 10 is being setup to control an appliance.

For instance a user may select an icon from multiple options for a household appliance the user desires to control. On a touch screen running setup software application it is contemplated that a user need only touch the display over one of the iconic representations for the targeted household appliance.

Remote control emulation may result in the display of a keypad as represented in each of FIGS. 4a-4c. In one exemplary embodiment of the remote invention the appliance front page for the universal remote would be similar to that illustrated in FIG. 2. As can be seen in FIG. 2 an appliance image key is provided for each appliance controlled by the universal remote. Upon activation of an appliance image key, a display corresponding to the command image keys for the selected appliance is displayed on the touch screen. In FIG. 4a an example of the command image keys that may be displayed for a DVD player are illustrated. In FIG. 4b an example of the command image keys that may be displayed for a TV are illustrated. In FIG. 4c an example of the command image keys that may be displayed for an alarm clock are illustrated. The command code signal, formats, image keys information and other data for each appliance are stored as a command code signal file in the remote control memory.

Further screen pages may be launched from the initial appliance front page screen for appliances having many functions, commands grouped together by common function (e.g. contrast, brightness, zoom . . . ) or other front page display pages that may simplify or make more convenient the operation of the appliance by precluding such command image keys from the initial screen.

As illustrated in FIG. 2, if the user selects and presses an image display key the graphical user interface of the universal remote control device 10 will cause a second screen to pop-up and be displayed. This front page screen may have soft keys for use in commanding the operation of the selected appliance. By way of example only, it will be appreciated that, if the user selects a displayed image key icon such as, by way of example, touching the display image key “DVD”, may cause a screen such as shown in FIG. 4a, to be displayed. Likewise a second front page screen such as that shown in FIG. 4b, may be a front page if command image key “TV” is pressed by the user. When the image key “Alarm Clock” is pressed, this may cause a third front page screen such as shown in FIG. 4c, to be displayed.

FIG. 4a illustrates a DVD player that identifies all its functionality on universal remote control display 20. Referring to FIG. 4a, the universal remote control 10 shows command image keys comprising those image keys recognizable and well known in the industry, a rewind icon, a stop icon, a pause icon, a play icon, and a fast forward icon. Since these are the only functions desired to be controlled, for example, with this particular DVD the user is presented with a universal remote control 10 having substantially reduced apparent complexity. This eases selectivity by reducing extraneous information.

If a different DVD model had a recording feature and a channel tuner in addition to the basic DVD functions the function of such a model on the universal remote control 10 may result in the touch screen display shown in FIG. 4d. Thus, the command image key data and corresponding command code signal data for an appliance once loaded into memory allows the universal remote control 10 to exhibit appliance function command image keys on a touch screen for a user. The universal remote control 10 accordingly thereby allows activation of controls available and supported by the appliance.

By employing a touch screen, one can dynamically generate remote control buttons, thereby avoiding the constraints associated with determining which particular buttons should be included in the design of a universal remote control, and which buttons should be left out. The touch screen on the universal remote control 10 permits it to be programmed so that for each emulated appliance remote control only command image keys used to control functions actually supported by the appliance are displayed and command keys for functions not supported by the appliance are not displayed. The number of appliances that can be controlled by the universal remote control 10 is in principle unlimited; however the amount of available memory in the universal remote control would limit the stored command signal files data and associated command image keys.

It is to be understood that soft keys displayed on a touch screen could be substituted for or used in conjunction with hard keys.

Also the remote control may be preprogrammed to permit a user to customize the universal remote control locally. A setup application may be invoked to customize the remote control commands. For instance the customization setup application can be performed using menu-driven software which cooperates with the graphical user interface to permit a user with the opportunity to enter customization setup information conveniently. For example, a setup application can be used to provide the user with the opportunity to access all of the infrared control codes required for operation of all of the household appliance command controls loaded in the remotes memory, delete or download command code signal files. [0022] U.S. Pat. No. 5,614,906 discloses a customization setup application and is incorporated herein by reference in its entirety.

As described in U.S. Pat. No. 5,614,906 a customization setup application permits the user to select control codes by linearly stepping through a database of codes by device type, trying each one in turn. A setup by code application permits the user to customize the remote by entering a known code number to configure the universal remote control 10 to make accessible the control codes for controlling an appliance(s).

In addition the remote control invention may include a new command code signal software application. The new software application allows the user to try a new command code signal from command code signal files received during a prior download over a network connection, a memory card or other method of inputting data. Means for setting up a remote control to control a given household appliance are well understood by those of ordinary skill in the art. For instance the customization setup application may permit a user to select a desired command code signal file for a household appliance by appliance type, manufacturer, or other category.

In addition to the front page appliance controls screens including controls specific to the selected appliance, basic functions for current appliances can be made available directly from the home page screen as shown in FIG. 2. By way of example, a direct power image key for each appliance can be located in the center of the touch screen display. If a user presses such a power image key the appliance power key selected causes the transmission of a defined control code to either turn on or off the appliance corresponding to the image key. Pressing a power image key for a TV (not shown) would cause the television to power on or off.

It should be noted that in the present invention that the physical buttons 29 may be programmable and may control functions such as navigation between screens, navigation within a screen, sending IR commands, altering the contents of memory within the remote control 10, or any other function that may be applicable.

At discussed above currently many household appliances, such as TV, Hi-fi, VCR, DVD players, alarm clocks, ceiling fans, toys and other appliance devices are controlled remotely via an infra-red link. Today some devices including but not limited to TV, Hi-fi, stereo systems, DVD players, wireless telephone networks and VCR players are manufactured to be controlled by a radio remote control signal. In addition garage door openers have always principally employed radio wave systems for communicating control signals. Further video game systems often employ radio wave remote controls for both controlling operation and interfacing with the game sets.

Such radio wave systems have resulted in the advent of wireless personal area network technology. These local wireless networks employ the unlicensed short-range radio within designated unlicensed bandwidths. WiFi is the trademark of the WiFi Alliance that refers to a range of connectivity technologies including wireless local area network based on IEEE 802.11 standards.

Today more wireless local area networks have high security typically using a frequency-hopping spread spectrum which chops up the data being sent and transmits it in different bandwidths. BLUETOOTH is one such well known wireless area network technology for exchanging data over short distances. BLUETOOTH network systems although originally intended for nonresidential and industrial purposes is now commonly used in household environments may connect multiple devices.

The remotes, appliances and all other networked devices in a BLUETOOTH network typically employ transmitter and/or receiver means utilizing two way radio communication on the ‘unlicensed’ 2.4 GHz waveband. A BLUETOOTH remote can facilitate communication between other local BLUETOOTH enabled devices, which are devices equipped with a BLUETOOTH transmitter and/or receiver means. Presently many appliance manufacturers equip their mobile phones, mousse, keyboards, printers, personal digital assistants, webpads, laptops, video game consoles, computer peripherals, NINTENDOS's Wii, SONY's PLAY STATION III, PSP GO and many other devices with BLUETOOTH transmitter and/or receiver means.

It is contemplated that the universal remote invention can be further adapted to include circuitry and software for communicating with appliances in a wireless local area network such as Wi-Fi, BLUETOOTH or other local wireless connectivity technologies.

U.S. Pat. No. 5,963,624 (Pope) which is hereby incorporated by reference in it entirety shows using a conventional digital cordless telephone also being employed as a remote control unit. The cordless telephone sends radio control signals to an interface unit, which in turn converts the control codes to infra red codes to control a television receiver.

In a preferred embodiment of a combination portable mobile phone-universal remote control of the present invention the interface unit circuitry includes the remote microprocessor 40. The microprocessor may be programmed for translating received ‘BLUETOOTH commands’ into transmitted ‘infra-red commands’. BLUETOOTH technology is well known in the telephone industry for locally communicating data between a mobile cellular phone and nearby appliances (e.g. earpiece). In the present invention non-volatile RAM 42 stores command code signals and sequences which may be programmed into the present universal remote (for example IR codes for a range of TVs, BLUETOOTH transmitted codes corresponding to particular key strokes), or by the user. Thus the microprocessor for instance may be configured to issue IR command code signals to control the TV channel, volume, etc. on receipt of a particular command input (e.g. touch screen image key display or physical button) on the universal mobile telephone-universal remote. It is contemplated that both portable household mobile phones and cellular phones may be adapted to jointly function as a universal remote transmitting and receiving both radio wave signals and infrared wave signals.

In the present invention the combination telephone-universal remote control device may be connected by a cable to a well known hearing earpiece so as to enable a person to simultaneously employ the combination device to both receive telephone calls with the earpiece and hold the universal remote outward in front of them to control an appliance (e.g. change the television channel).

For instance a preferred embodiment of the present universal remote control system may be used for controlling a television IR receiver and BLUETOOTH game console. The universal remote control system would comprise of a hand held universal remote 10 adapted to send both IR signals and short range radio wave signals

For remote controlling, often infrared emissions are used with frequencies between 20 kHz and 100 kHz. To operate and control electronic appliances having signals for instance in the short range unlicensed frequency range 2.4 GHz the universal remote control device 10 would need a signal emitter and receiver 27 capable covering this range. The universal remote 10 could be adapted to transmit both the immediately above mentioned infrared range and a desired radio frequency range by employing well known electromagnetic signal transceiver technology.

The signal transmitter/receiver 27 should also be able to detect the signals of the corresponding original remote control devices; the signal transmitter also has to cover this range for communicating with the appliances. The terms “emitter”, “receiver” or “transceiver” are not limited to a dual item or units working with a dual protocol but may be a multimode of emitters and receivers compatible with many different manufactured wireless appliances. They can be any signal receiver and emitter working with any electromagnetic radiation that can be effectively used for remote controlling. The signal receiver means and transmitter means 27 are preferably wireless receiver means and transmitter means, the word “wireless” should be interpreted widely and includes not only infra-red, as well as radio frequencies, especially short range radio protocols, e.g. BLUETOOTH but at least optical and ultraviolet transceivers as well or other transmission mediums.

In addition to mobile phones some personal digital assistants, webpads, palm computers and the like are sufficiently versatile to be used as remote control devices. The range of physical buttons, displays and processors typically provided on these devices allow for a wide range of commands to be programmed into these devices (e.g. cellular phone) and accessed rapidly by the user.

The programming, command code signal files recognizable and appropriate for the identified appliance and/or function data can be loaded into the universal remote control memory by inserting a memory card such as a Sanisk (SD) card into a the universal remote controls 10 memory card slot 28. The card slot is capable of receiving a SD card. Multiple and/or different memory card slots for different memory card formats may also be incorporated with the universal remote control 10.

The universal remote control 10 in a preferred embodiment may also have a computer mouse, integrated physical keyboard buttons or touch screen image keyboard. It might be desirable for certain programming tasks to be performed using companion software with an IR keyboard in conjunction with the universal remote control's display, personal computers display or another display. The IR mouse and IR keyboard features on the universal remote may allow for a user to operate the personal computer using personal computer software or browse the internet using game console internet surfing software as well known in the art. The keyboard and mouse features may facilitate input of data for many consumers that are used to such input means. U.S. Pat. No. 7,123,242 to (Henty) and US Patent Application Publication No. 2006/0038698 (Chen) are both incorporated in their entirety herein by reference. Both references detail remote control keyboards with an integral mouse positioned thereon.

Either well-known remote pointing position or motion control may be employed. A cursor or highlighting control will either be based on where the remote is pointing on the screen or will simply change based on the change in the imager axis offset position from frame to frame. In a multi-media system with internet access (an internet access enabled TV), digital TV, and video game capability it may be desirable to switch modes from pointing position to motion control depending or a user may select one mode.

In another embodiment of invention the above described central database on the World Wide Web will include command code signal files for the myriad of wireless keyboards and wireless mouses in the industry.

The universal remote can be programmed to operate an appliance such as an alarm clock. For instance the alarm clock would include a numerical display, a speaker and an infrared receiver. An infrared signal may be transmitted to the alarm clock to set the alarm clock. When a particular set time is reached the alarm clock speaker will produce an audible alarm signal.

In addition the universal remote control 10 may be programmed to include command code signals for activating a snooze control circuit within the alarm clock. U.S. Pat. No. 6,163,507 (Gholson) is herein incorporated by reference in its entirety.

In an alternative preferred embodiment the universal remote control 10 could be initially programmed to include well-known alarm clock software, including a snooze function. The universal remote includes an internal clock 44. The universal remote 10 can be programmed at times selected by the user to transmit IR command code signals to preselected appliances. Said preselected appliances for instance would have audio capability for awakening a user. The preselected appliances by a user might also include appliances that activate visible light to illuminate a bedroom.

It should be appreciated that after the alarm timer(s) is setup the universal remote control should be placed to direct the IR transceiver 27 toward a signal receiver of the controlled appliance. The universal remote control 10 transmits command control codes to the appliances when the set time or time period is reached.

If the alarm clock programming is not initially included by the universal remote manufacture it may for instance be later loaded from the above described central database into the universal remote control by the user.

Another option that may be included in the present invention would be to include a speaker on the universal remote control for signaling the alarm as is well-known for instance in the cellular phone industry. Cellular telephones are adapted to include software that allows a person to employ the cellular phone as an alarm clock.

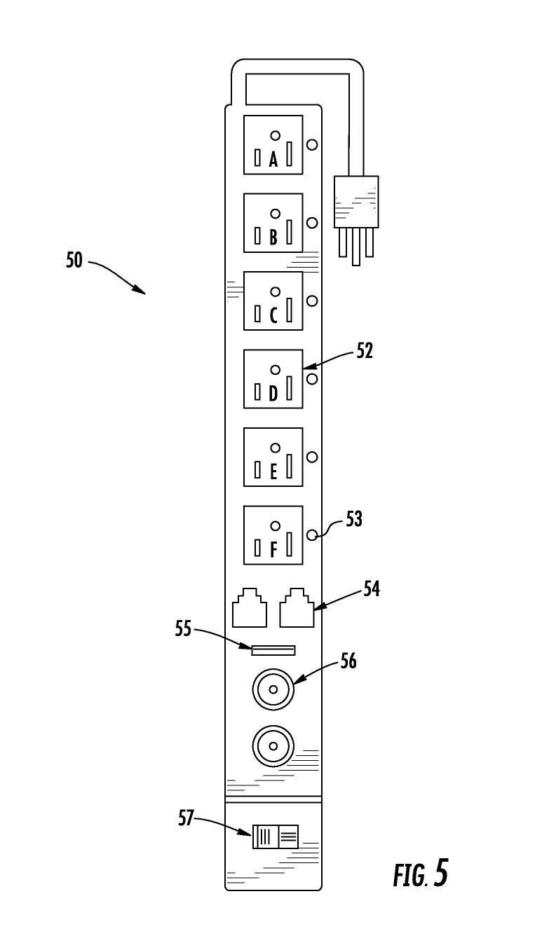

FIG. 5 illustrates a surge protected power strip 50 for use with a universal remote of the present invention. The power strip itself includes a microcontroller for controlling functionality. More particularly, the power strip 50 includes a plurality of three prong power outlets 52 (A-F) adapted to receive appliance plugs. The power strip 50 may comprise a corresponding electrical switch (not shown) for each outlet on the power strip illustrated in FIG. 5. The power strip has four infrared receivers 53, each receiver 53 corresponds to just one power outlet 52 (C,D,E,F). Well known control circuitry is included within the power strip that upon receipt of codified infrared signal opens or closes the switch for a socket 52. It is contemplated that each sockets switch is actuated only upon receipt of a unique infrared signal transmitted from the universal remote 10 to the corresponding infrared receiver 53. Each infrared power socket (C, D, E, F) switch is actuated by a unique individual infrared code signal.

For example, a fan may be plugged into a socket “F”. A user of the universal remote may press an identifying image key representing socket “F” on the display screen 20 of the present universal remote 10. Upon activation of the “F” socket image key, the universal remote transmits a coded infrared command signal that is received by the infrared receiver 53 for socket F. Accordingly the appliance(s) plugged into a socket “F” will either be powered on or shut off.

It is further contemplated that the control circuitry for the power strip 50 can be adapted to incorporate well-known off and on delay timers for each remotely controlled socket (C-F). Either well known power-off time delay circuitry or software programs may be incorporated into the power strip circuitry of the present invention to permit an appliance, such as a computer, to go into standby mode and complete the proper shutdown sequence and necessary data access. Most appliances that are microprocessor-based require a time delay (e.g. 30 seconds) before total power shutdown.

Similarly, the power strip circuitry of the present invention may have a power on delay timer program to enable a person to set a future time that the power socket turns on. For instance a person may choose to plug a light in socket “F” and program socket “F” to turn on at 7:00 am in the morning. U.S. Pat. No. 6,661,123 (Hsu), U.S. Pat. No. 6,529,392 (Nishida et al.), U.S. Pat. No. 4,769,555 (Pequet et al.) and U.S. Pat. No. 6,628,083 (Pickering) are hereby incorporated in their entirety.

The remotely controlled power strip also has two standard power outlet sockets (A, B) that are not remotely controlled. In addition the power strip has two Ethernet cable ports 54, a USB port 55 and two RFU connectors 56 (e.g. for cable television).

In addition the power strip 50 has a manual on/off master power switch 57. The master switch 57 may be used to turn the power strip on or off. The master switch may control whether all of the outlets are on or whether all of the outlets are off. To protect the power strip 50 from overheating and limit any fire hazard the power strip includes a well known thermostat circuit breaker. U.S. Pat. No. 5,049,849 (Sullivan et al.) is hereby incorporated by reference in its entirety.

The user may configure the power strip in such a manner that the outlets are individually controllable. The USB port may be employed to communicate data between the power strip 50 and the universal remote control 10. For instance it is contemplated that the USB port 55 on the power strip could be coupled to the USB port 23 on the universal remote and USB port 26 connected to a host computer 32 for the purpose of programming and/or transferring other data to at least the universal remote. For instance the computer may transfer to the universal remote command code signals, command software and other data.

In another preferred embodiment universal remote control 10 may include a well known voice command circuitry (not shown) feature for operating the universal remote control in a hands-free manner. The voice command circuitry comprises a microphone, an audio switching circuit, a sound activation circuit, and a speech recognition circuit. The transmitter means 27 is connected for activation by the voice command circuitry. US Patent Application Publication No. 2004/0128137 (U.S. Pat. No. 7,080,014; Bush et al.) are incorporated herein by reference. For instance the voice commands are converted into infrared command code signals for controlling the appliances. In particular the output from the speech recognition circuit communicates with an infrared signal controlling unit for activating one or more infrared light emitting diodes. The LEDs transmit infrared light in one or more wavelengths. The pulses emitted from the LEDs generally transmit the standard binary codes designated for a type appliance, brand and model. The binary IR command code signals are familiar to those skilled in the art. The IR transmission signals via the LEDs communicate instructions to a controlled appliance.

In a further embodiment a hands-free headset or earpiece could transmit radio signals to the universal remote control 10. These radio signals received by an antenna (not shown) on the universal remote control are translated and converted into an image key (or physical button) input command by an internal universal remote control program. This input command is received and processed by the universal remotes microcontroller to transmit command code signals for operating the desired appliance. Local handsfree communication appliances are well known in the art. U.S. Pat. No. 5,794,163 (Paterson et al.), U.S. Pat. No. 5,802,167 (Hong) and U.S. Pat. No. 6,154,539 (Pitel) are incorporated by reference in their entirety.

In another preferred embodiment the universal remote control may include a log-in region on the home page display. A known registered user must enter a log-in name and password, respectively to use the universal remote control 10. In addition a region on the home page display screen has a registration page where a new user may be directed to a registration page. A user may communicate the required log-in information by a touch-sensitive screen or on a GUI displayed on a television employing a pointing device or other well-known input method.

The universal remote control 10 embodiments may have a rechargeable battery (not shown), such as a lithium battery, for supplying power to the universal remote control 10. The universal remote control 10 may have a second USB port 26 that may be used for connection to a power supply source to charge the rechargeable battery.

Alternatively the universal remote control 10 might employ “off the shelf” disposable batteries, such as but not limited to alkaline batteries. In a preferred embodiment of the invention the remote may be adapted to incorporate either rechargeable lithium battery or disposable battery(s). In said embodiment the disposable batteries are first enclosed in a battery case that mimics the shape and size of the rechargeable lithium battery, and then inserted in the universal remote control as a substitute for the rechargeable lithium battery.

The power source also communicates with a flashlight 22 having an independent manual power switch. The universal remote may also be powered by a transformer connected to a standard wall socket as well known in the art, solar cells or other electrical power sources.

In yet another embodiment the universal remote may be designed to have a body with a flip cover for covering at least the physical push button area 29 and maybe the display screen. U.S. Pat. No. 7,236,588 (Gartrell) and U.S. Pat. No. 7,200,426 (Kawamura) are incorporated by reference in their entirety. A still further embodiment of the universal remote control invention may include a slidable cover that in one position covers the physical button area 29 and in a second position covers the universal remote controls physical button area 29. U.S. Pat. No. 7,003,104 (Lee), U.S. Pat. No. 7,419,099 (Lee et al.) and U.S. Pat. No. 7,813,776 (Lee et al.) are incorporated by reference in their entirety.

It will be understood that each of the elements described above, or two or more together may also find a useful application in other types of methods differing from the type described above.

The present invention universal remote control is not intended to be limited to audio-video entertainment appliances for instance but is intended to encompass all appliances either domestic or industrial that may be controlled by a universal remote control. A homeowner could have electrical switches installed in his house, a hot tub, a television, a stereo and a ceiling fan, all of which are capable of having functions thereof controlled through a universal remote control device.

The universal remote control apparatus can be manipulated to display a control touch screen for the all light switches in a room, with a dimming feature for each of the lights. Each light fixture may include a fixture thereon having a programmable microcontroller timer that may be programmed by the universal remote control 10. Each light may have a small USB port for communicating data between the universal remote control 10 and a light fixtures microcontroller. On a separate display screen, control image keys are displayed for individually controlling the speed of a ceiling fan. It is also contemplated that the universal remote control might include an image key on the main menu for a household security system having a plurality of electric door locks, a plurality of different alarms, plurality of sensor and plurality of responses including but not limited to notifying police, audio and illumination means.

In addition the universal remote control could be used to operate in industrial environments. For instance the universal remote can be employed to operate computer controlled machinery, office equipment and robots for instance.

Preferred embodiments of the universal remote control 10 of the present invention have just been described and illustrated above. It is to be understood for these descriptions, that the specific screen layouts, navigational algorithms, and described functions of the buttons and/or image keys, may be modified greatly without departing from the concepts of the present invention.

While certain novel features of this invention have been shown and described, it is not intended to be limited to the details above, since it will be understood that various omissions, modifications, substitutions and changes in the forms and details of the universal remote control device illustrated and in its operation can be made by those skilled in the art without departing in any way from the spirit of the present invention.

The invention claimed is:

1. A method for providing command code signals for remote controlled appliances onto a universal remote control, comprising:
providing a universal remote control,
providing an Internet server having a centralized appliance database with information and said command code signals for a plurality of said remote controlled appliances;
said plurality of remote controlled appliances have different manufacturers, providing access to said Internet server having a centralized appliance database,
said command code signals including command code signals emitted by original appliance remote controls,
said universal remote control having a microprocessor and memory,
said universal remote control having a data cable port for connecting to the Internet,
directly or indirectly connecting said universal remote control to the Internet,
entering data for a selected remote controlled appliance over the Internet into said centralized appliance,
sending a request to said Internet server for programming command code signals for said selected remote controlled appliance onto said universal remote control,
downloading said requested command code signals from said centralized appliance database over said Internet into said universal remote control memory,
said loaded command code signals enabling said universal remote control to control said selected appliance.

2. The method of claim 1, wherein said appliance data entered into said centralized appliance database includes make, model number and device type.

3. The method of claim 1, further comprising said universal remote control detecting and learning command code signals from an at least second appliance original remote control.

4. The method of claim 3, wherein said universal remote control learning can occur only if said universal remote control is connected to the Internet.

5. The method of claim 1, wherein said code signals are infrared code signals.

6. The method of claim 1, wherein said connecting said universal remote to the Internet is a wireless connection.

7. The method of claim 1, further comprising entering appliance data for a second selected remote controlled appliance over the Internet into said centralized appliance database,
sending a request to said Internet server for programming command code signals for said second selected remote controlled appliance,
downloading said requested second selected appliance command code signals from said centralized appliance database over said Internet into said universal remote control memory,
said loaded second appliance command code signals enabling said universal remote control to control said second selected appliance.

8. A combination cellular phone-universal remote control comprises,
a microphone and speaker,
a first receiver for infrared signals, and a second receiver for radio wave signals,
a first transmitter for infrared signals, and a second transmitter for radio wave signals,
a manual command input device,
a programmable microprocessor and memory, wherein said microprocessor is programmed to translate a digital command input from said command input device into an infrared code signal, said infrared code signal transmitted by said first infrared transmitter to control a targeted appliance,
radio wave command code signals and infrared command code signals for appliances are stored in said memory,
a data cable port for downloading said infrared command code signals,
said microprocessor configured to receive command control data from said manual input device and translate said control data into either said radio wave command signals or said infrared command code signals for controlling targeted appliances.

9. A combination cellular phone-universal remote control according to claim 8, wherein said manual command input device is a touch screen,
said microprocessor running at least one appliance software application, said at least one appliance software application generating a display on said touch screen.

10. A combination cellular phone-universal remote control according to claim 9, wherein said display is a graphic representation that closely resembles an original remote control for said targeted appliance, said graphic representation has graphical user command keys for controlling functions of said targeted appliance.

11. A combination cellular phone-universal remote control according to claim 10, wherein said at least one appliance software application is downloaded from an Internet server to said cellular phone-universal remote control.

12. A combination cellular phone-universal remote control according to claim 10, wherein said radio waves signals are BLUETOOTH signals.

13. A combination cellular phone-universal remote control according to claim 12, further comprising a memory card slot.

14. A combination cellular phone-universal remote control according to claim 9, further comprising internal clock software, said clock software generating a graphical display that has graphical user command keys representing alarm clock controls, said displayed alarm clock command keys used to select the operation of a targeted appliance at a desired time.

15. A combination cellular phone-universal remote control according to claim 10, comprising a plurality of appliance software applications wherein said plurality of appliance software applications displays a different graphical representation of a remote control on the cellular phone-universal remote control, and storing a collection said plurality of appliance software applications.

16. A surge protected power strip remote control system comprising,
a power strip,
said power strip having a microcontroller, a plurality of power outlets, a plurality of infrared receivers and a plurality of switches,
each switch connected to only one of said plurality of power outlets,
each infrared receiver connected to only a corresponding one of said plurality of power outlets,
said microcontroller programmed to actuate one of said switches upon receipt of a unique command code signal by one said corresponding infrared receivers.

17. A surge protected power strip remote control system according to claim 16, comprising
a universal remote control having a touch screen, microprocessor and memory,
said universal remote control running software for generating a display on said touch screen, said display has graphic representations for each said plurality of power sockets.

18. A surge protected power strip remote control system according to claim 17, comprising
power off and on delay control circuitry or microcontroller delay software for each switch.

19. A surge protected power strip remote control system according to claim 18, comprising
microcontroller timer software for programming a power switch to actuate a power outlet at a set time in the future.

20. A method of claim 1, wherein upon entering data and requesting command codes for at least a second selected remote controlled appliance from said centralized appliance database no command code signals are available at said centralized appliance database for downloading onto said universal remote control,
providing a power strip having a plurality of power outlets, each power outlet programmed to power on or off upon receipt of a unique command code signal for each said plurality of outlets,
connecting said at least second selected remote controlled appliance to said power strip.
